(19) United States
(12) Patent Application Publication
(10) Pub. No.: US 2007/0201734 A1
(43) Pub. Date: Aug. 30, 2007

(54) Automated multicolor fluorescent microscope with scanning and thermostatic ability

(75) Inventor: Oleg S. Alferov, Bolingbrook, IL (US)

Correspondence Address: JOAN PENNINGTON, 535 NORTH MICHIGAN AVENUE, UNIT 1804, CHICAGO, IL, 60611, US

(73) Assignee: THE UNIVERSITY OF CHICAGO

(21) Appl. No.: 11/362,484

(22) Filed: Feb. 24, 2006

(51) Int. Cl. G06T 7/20; G06F 19/00

(52) U.S. Cl. 382/128; 62/156; 702/19

(57) ABSTRACT

An automated multicolor fluorescent microscope of the invention includes thermostatic and thermal cycling capability with a wide temperature range, such as a range between −40 to 110 Celsius degrees, and precision of temperature setting and independency of ambient conditions, wide area of observation, high uniformity of illumination and includes capability to change emission and excitation filters automatically and independently.

### CONTRACTUAL ORIGIN OF THE INVENTION

The United States Government has rights in this invention pursuant to Contract No. W-31-109-ENG-38 between the United States Government and Argonne National Laboratory.

### FIELD OF THE INVENTION

The present invention relates to an improved microscope, and more particularly to an automated multicolor fluorescent microscope with scanning and thermostatic and thermal cycling capability, wide area of observation, high uniformity of illumination and calibration.

### DESCRIPTION OF THE RELATED ART

A need exists for an improved microscope that combines multiple capabilities in one device. A need exists for such a microscope that includes thermostatic and thermal cycling capability with a wide temperature range and precision of temperature setting and independency of ambient conditions.

A need exists for such a microscope that includes a wide area of observation, high uniformity of illumination and calibration. A need exists for such a microscope that includes capability to change emission and excitation filters automatically and independently, that is enables true multicolor.

A need exists for such a microscope that enables making comparisons of experiments to be performed under multiple different operating selections, such as different exposure times, different excitation intensities, and the like, to compare results from experiments performed at different times and in different laboratories.

A need exists for such a microscope that is fully automated and that includes capability to perform long experiments without being controlled by an operator.

A principal aspect of the present invention is to provide an enhanced automated microscope.

Other important aspects of the present invention are to provide such enhanced automated microscope substantially without negative effect and that overcome some of the disadvantages of prior art arrangements.

### SUMMARY OF THE INVENTION

In brief, an automated microscope is provided. The microscope includes a temperature table including a thermal control subsystem for controlling a selected temperature of the temperature table. The temperature table includes a first stage liquid heat exchanger and a second stage fast temperature control. An environmental conditioning subsystem provides humidity control to prevent dew and ice from developing at a working side of the temperature table. A computer is coupled to the first stage liquid heat exchanger and the second stage fast temperature control for maintaining the selected temperature. The computer is coupled to the environmental conditioning subsystem for maintaining humidity control.

In accordance with features of the invention, the microscope includes thermostatic and thermal cycling capability with a wide temperature range, such as a range between −40 to 110 Celsius degrees, and precision of temperature setting and independency of ambient conditions.

An automated multicolor fluorescent microscope of the invention includes a liquid light guide directing light from a light source to a fiber optic ringlight. A plurality of excitation filters is mounted on a first filterwheel exchanger for receiving excitation light from the fiber optic ringlight and filtering the excitation light being applied to a specimen. A plurality of emission filters is mounted on a second filterwheel exchanger for receiving emission light from the specimen and filtering the emission light. The excitation filters and emission filters are selectively provided to have different wavelength ranges that do not overlap. A computer is coupled to the first filterwheel exchanger and the second filterwheel exchanger for independently changing the excitation filters and the emission filters. A charge coupled diode (CCD) camera detects the filtered emission light.

In accordance with features of the invention, the microscope includes a wide area of observation, high uniformity of illumination and includes capability to change emission and excitation filters automatically and independently.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a schematic and block diagram representation illustrating an automated multicolor fluorescent microscope with scanning and thermostatic and thermal cycling capability, wide area of observation, high uniformity of illumination and calibration in accordance with the preferred embodiment;

FIG. 2 is a schematic and block diagram representation illustrating an illumination subsystem of the automated multicolor fluorescent microscope of FIG. 1 in accordance with the preferred embodiment;

FIG. 3 is a schematic and block diagram representation illustrating a detection subsystem of the automated multicolor fluorescent microscope of FIG. 1 in accordance with the preferred embodiment;

FIG. 4 is a schematic and block diagram representation illustrating a thermal control subsystem of the automated multicolor fluorescent microscope of FIG. 1 in accordance with the preferred embodiment;

FIG. 5 is a schematic and block diagram representation illustrating a position control subsystem of the automated multicolor fluorescent microscope of FIG. 1 in accordance with the preferred embodiment;

FIG. 6 is a schematic and block diagram representation illustrating a environmental control subsystem of the automated multicolor fluorescent microscope of FIG. 1 in accordance with the preferred embodiment; and

FIG. 7 is a schematic and block diagram representation illustrating a computer control subsystem of the automated multicolor fluorescent microscope of FIG. 1 in accordance with the preferred embodiment.

### DETAILED DESCRIPTION OF THE PREFERRED EMBODIMENTS

In accordance with features of the invention, an improved microscope is provided that combines multiple capabilities in one device. The microscope includes thermostatic and thermal cycling capability with a wide temperature range and precision of temperature setting and independency of ambient conditions. The microscope includes a wide area of observation, high uniformity of illumination and calibration. The microscope includes capability to change emission and excitation filters automatically and independently. The microscope enables true multicolor.

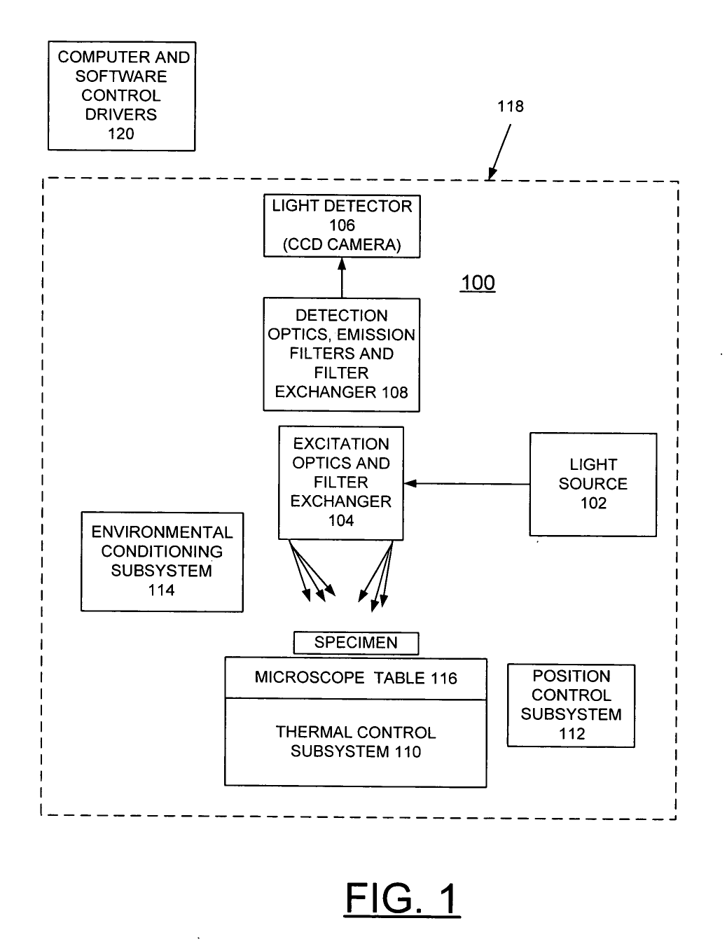

Having reference now to the drawings, in FIG. 1, there is shown a schematic diagram representation of an automated multicolor fluorescent microscope generally designated by the reference character 100 in accordance with the preferred embodiment. Automated multicolor fluorescent microscope 100 includes scanning and thermostatic and thermal cycling capability, wide area of observation, and high uniformity of illumination and calibration capabilities.

In accordance with features of the invention, the improved microscope 100 enables making comparisons of experiments done under different operating selections, such as different exposure times, different excitation intensities, and the like, to compare results from experiments performed at different times and in different laboratories. The microscope 100 is fully automated and includes capability to perform long experiments without being controlled by an operator.

Among the major components of automatic fluorescent microscope 100 are an illumination source 102, excitation optics and filter exchanger 104, a light detector 106, such as a charge coupled diode (CCD) camera 106, detection optics for detection of fluorescence, emission filters and filter exchanger 108, a thermal controlling subsystem 110, a positioning subsystem 112, an environmental conditioning subsystem 114, such as for humidity control, a microscope table 116, a microscope body 118, and a computer and software control subsystem 120.

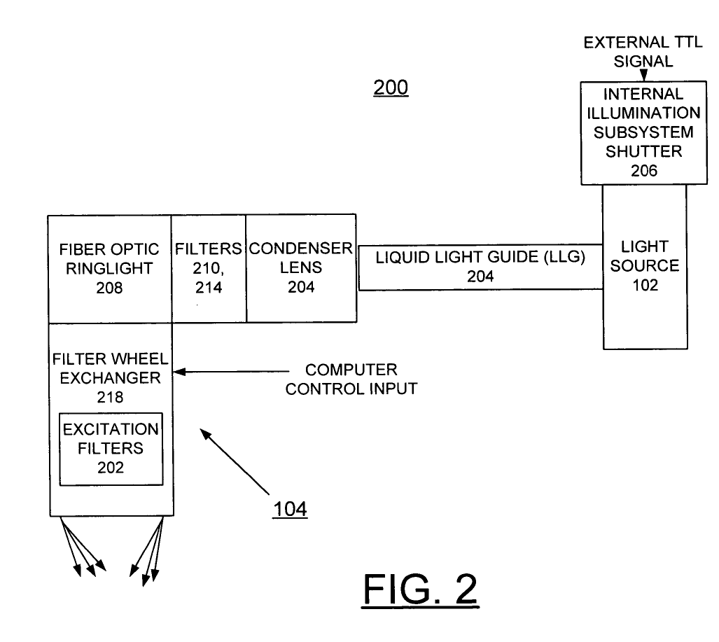

Referring also to FIG. 2, there is shown an exemplary illumination subsystem generally designated by the reference character 200 in accordance with the preferred embodiment. Illumination subsystem 200 includes illumination source 102 and excitation optics and filter exchanger 104. The illumination source 102 is implemented, for example, with a NovaLight LG Illuminator with Model A-1010B Arc Lamp Housing manufactured and sold by Photon Technology Int., powered by LPS-220B stabilized power source also commercially available from Photon Technology Int. The NovaLight LG unit accepts either 100-Watt Mercury lamp, or 75-Watt Xenon lamp. Both lamps are commercially available from Photon Technology Int. In one implementation of microscope 100, the microscope uses 100-Watt Mercury lamp.

The white light of illumination source 102 is delivered to a plurality of excitation filters 202 of the excitation optics and filter exchanger 104 by a liquid light guide (LLG) 204, for example, with core diameter 2 mm (Photon Technology Int.). The illumination subsystem has an internal shutter 206 controlled by external TTL signal.

The illumination light is directed into a fiber optic ringlight 208 through bandpass filters 210. The illumination light from liquid light guide 204 is accepted by a condenser lens 112 having, for example, a focal distance 17 mm, goes as a parallel beam through a filter 214 and enters the fiber optic ringlight bundle 208. The actual distance between a termination of the LLG 204 and the condenser lens 212 is selected so the beam diameter is 7-9 mm. The excitation filters 202 are mounted into a filterwheel exchanger 218.

The fiber optic ringlight 208 is implemented, for example with a device having ring inner diameter 66.3 mm and core diameter 9.4 mm commercially available from Stockers & Yale, Inc. The bandpass filters 210 are implemented, for example with diameter 25 mm, made by Chroma Technology, Inc. Condenser lens 112 is commercially available from Linos Photonics.

The illumination from the fiber optic ringlight bundle 208 provides very uniform illumination without sacrificing the illumination intensity. The fiber optic ringlight 208 includes adjustable mountings on both ends in the excitation subsystem 104 and at the microscope table 116 allows to improve illumination even further.

The filterwheel exchanger 218 is implemented, for example, with a filterwheel exchanger model ENR0322 for 10 positions of 25 mm round filters, manufactured and sold by LUDL Electronics Products. The filterwheel exchanger 218 includes a control unit and is controlled, for example, by a MAC5000 DC wheels unit also manufactured and sold by LUDL Electronics Products, and is connected to computer 120, for example, via an RS-232 serial interface connection.

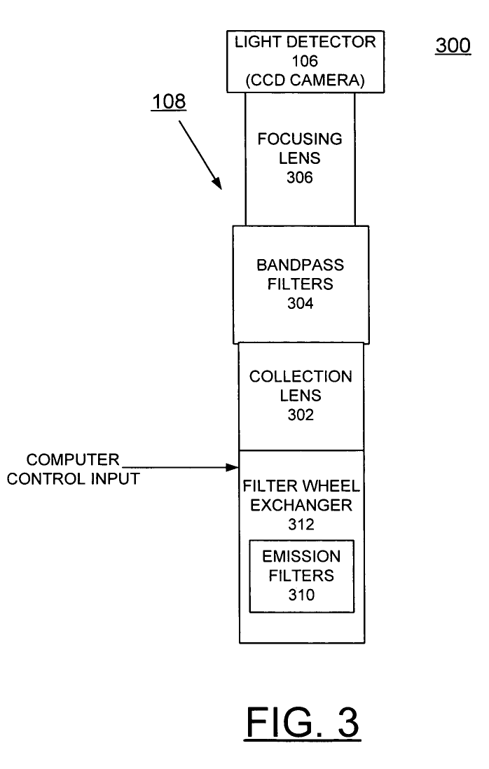

Referring also to FIG. 3, there is shown an exemplary detection subsystem generally designated by the reference character 300 in accordance with the preferred embodiment. Detection subsystem 300 includes light detector 106, preferably implemented with a CCD camera, and the detection optics for detection of fluorescence, emission filters and filter exchanger 108.

Light detector 106 is implemented, for example, with generally any monochrome CCD camera, preferably with a C-mount. For example, a 12-bit CCD camera 106 typically offers a good compromise between sensitivity, precision and price. In one implementation of microscope 100, a scientific-grade cooled 12-bit SenSys CCD camera model 1602E by Roper Scientific, Inc., having resolution 1536×1024 and sensor size ⅔″ is used.

Detection optics for detection of fluorescence, emission filters and filter exchanger 108 includes a collection lens 302, a bandpass filter 304, a focusing lens 306, a plurality of emission filters 310 and a filter exchanger 312. In the microscope 100, the excitation light causes the fluorescent substance to emit weak light with wavelength slightly different from the excitation one.

The emission light is collected by for example, a 83 mm Heligon F/2.0 lens 302 by Linos Photonics and directed through bandpass filter 304, for example having a diameter 50 mm by Omega Optical to the identical lens 306 that focuses the light onto the sensor of CCD camera 106. Thus, this is 1:1 optical scheme, providing approximately 13.8×9.2 mm field of view with ⅔″ CCD camera with 1536×1024 resolution.

In accordance with features of the invention, the pair of the excitation filters 202 and emission filters 312 are specifically selected that their wavelength ranges do not overlap, so only the fluorescence is collected and all reflections of the excitation light is blocked. Special attention is paid to the optical components and connections to prevent light leaks and internal reflections.

The emission filters 312 are mounted into the filterwheel exchanger 314, such as a filterwheel exchanger model ENR0321 for 5 positions of 51 mm round filters, made by LUDL Electronics Products. The filterwheel exchanger 312 is controlled by the MAC5000 DC wheels unit (LUDL Electronics Products), connected to computer via an RS-232 serial interface connection. Note that a single, common MAC5000 controller can control both filterwheel exchangers 218, 314.

Each lens 302, 306 is attached to the microscope body 118 by a custom-made lens holder. The upper lens holder for lens 306 has a C-mount thread to attach the CCD camera 106, and the lower lens holder for lens 302 has an outside diameter 65 mm to accept the ringlight illuminator 208.

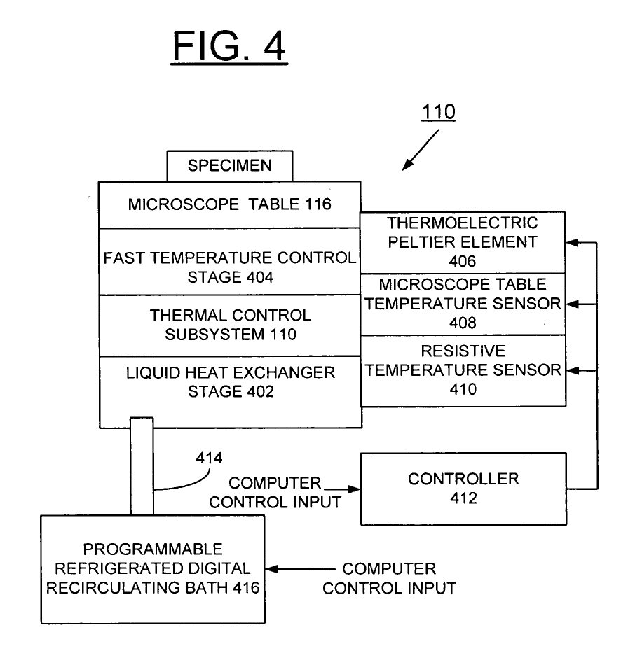

Referring also to FIG. 4, there is shown an exemplary thermal control subsystem 110 of the automated multicolor fluorescent microscope 100 in accordance with the preferred embodiment in accordance with the preferred embodiment. In accordance with features of the invention, microscope table 116 has the ability to maintain and change temperature in the range from −40 to 110 Celsius degrees.

Microscope table 116 includes the thermal control subsystem 110 having a first stage 402 and a second stage 404. The first stage 402 is a bottom liquid heat exchanger, such as manufactured and sold by Melcor, for cooling and coarse and slow temperature control. The second stage 404 is a top stage for fine and fast temperature control. The temperature on the top table is controlled by a thermoelectric Peltier element 406, also for example, manufactured and sold by Melcor. An actual temperature feedback is measured on the table by microscope table temperature sensor 408 or AD590 sensor manufactured and sold by Digi-Key. The precision of the temperature hold is 0.5 Celsius degrees, and the repeatability is better that 0.1 Celsius degrees. The thermal control subsystem 110 also includes an overheating detector defined by a resistive temperature sensor 410 manufactured and sold by Wavelength Electronics.

A controller 412, such as a 40-Watt thermocontroller model LFI-3751 made by Wavelength Electronics, drives the sensors 408, 410 and Peltier element 406. The liquid heat exchanger stage 402 is connected by a tubing 414 with programmable refrigerated digital circulating bath 416, such as a 1-kWatt 6-liter Programmable Refrigerated Digital Circulating Bath from Cole-Parmer. Computer 120 controls both devices 412, 416, such as, through an RS-232 serial interface connection, allowing the software control of temperature.

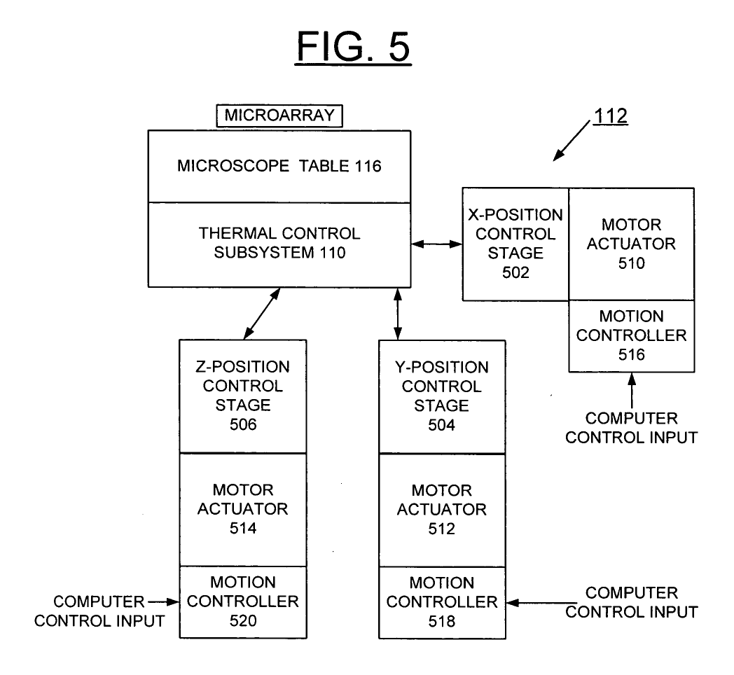

Referring also to FIG. 5, there is shown an exemplary position control subsystem 112 of the automated multicolor fluorescent microscope 100 in accordance with the preferred embodiment. Microscope table 116 has square 75 mm mount plate, such as a 112 M-BK-3A manufactured and sold by Newport for attaching it to the positioning subsystem 112.

Microscope table 116 advantageously is selectively positioned in all X, Y and Z directions providing an expanded observable area by 50 mm in all horizontal directions. The purpose of Z directional positioning is focusing of the slide under the objective. The Z travel is 12.5 mm. Position control subsystem 112 includes a plurality of stages 502, 504, 506. Each stage is driven by a respective motor actuator 510, 512, 514, such as an 850G motor actuator manufactured and sold by Newport. The horizontal X stage 502, and Z stage 506 are built, for example, from two linear translation stages model M-SDS65 manufactured and sold by Newport, and the vertical stage 504 is built, for example, from translation stage model M-MVN80 manufactured and sold by Newport.

Each of the motor actuators 510, 512, 514 is controlled by a respective motion controllers 516, 518, 520 made by Newport, either MM3000, ESP300 or ESP6000. The motion controllers 516, 518, 520 receives commands from computer, such as, via an RS-232 serial interface connection.

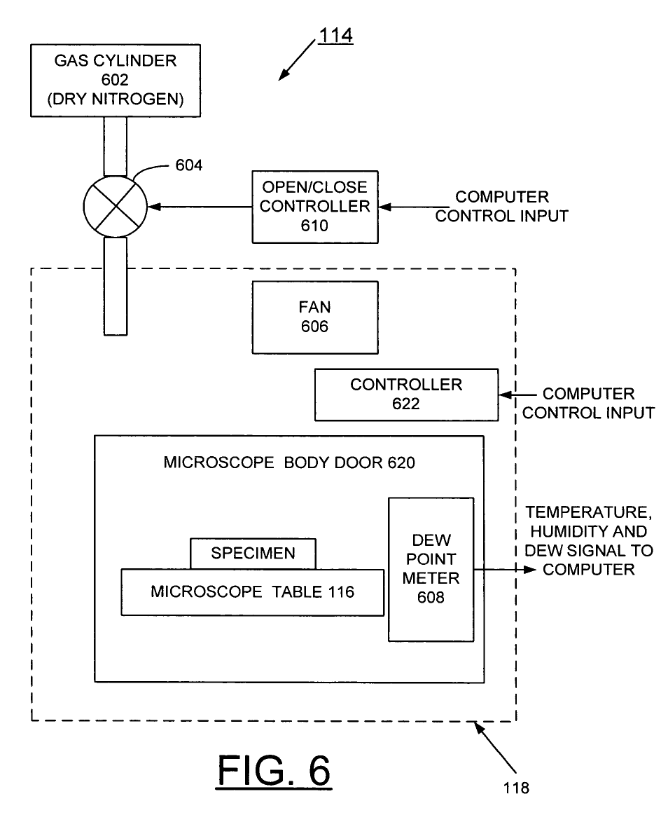

Referring also to FIG. 6, there is shown an exemplary environmental control subsystem 114 of the automated multicolor fluorescent microscope 100 in accordance with the preferred embodiment. In accordance with features of the invention, microscope table 116 has the ability to implement image acquisitions at low temperatures without being adversely affected by precipitation typical of humid environments.

To prevent dew or ice from developing on the working side of the table 116, an external gas cylinder 602 stores, for example, dry nitrogen that can be blown into the microscope chamber 118. A gas valve 604, such as a valve manufactured and sold by Kiser Controls, controls the nitrogen flow. An electric fan 606, such as a 1½″ 12 volt fan, is used to mix the air and the dry gas in the chamber 118. A dew point meter 608 measures temperature, humidity and dew at the table point 116. A Dew Point Meter model EW-37950-12 from Cole-Parmer together with a data cable connection to the computer 120 can implement the dew point meter 608.

An open/close controller 610 controls valve 604 receiving a computer input signal from computer 120, for example, via parallel port. The dew point meter 608 communicates with computer 120, for example, via an RS-232 serial cable. Gas pressure can be manually adjusted to allow enough amount of dry gas to enter the chamber, for example, based upon a minimum working temperature in the particular experiment.

Microscope body 118 defines a chamber that blocks the ambient light and helps to maintain low humidity. A front door 620 opens allowing user to access the table 116. Microscope body 118 is custom-built primarily using parts commercially available from Linos Photonics, Newport, Ealing, McMaster Carr, and Newark Electronics. A microscope controller 622 provides control functions for microscope 100 that accepts, for example, parallel cable to parallel port in the computer 120.

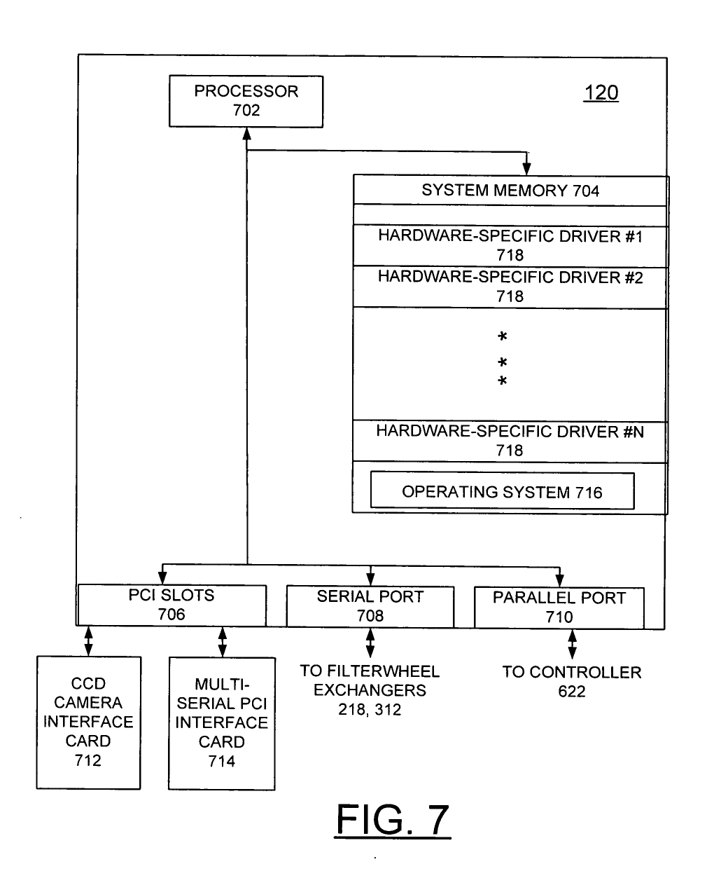

Referring also to FIG. 7, there is shown an exemplary computer and software control subsystem 120 of the automated multicolor fluorescent microscope 100 in accordance with the preferred embodiment. Computer and software subsystem 120 includes a processor 702, such as a Pentium 4 2 GHz, and a system memory 704, such as 512 MB RAM. As shown, computer and software subsystem 120 includes a plurality of PCI slots 706, at least one serial port 708 and at least one parallel port 710.

A pair of interface cards 712, 714 occupies PCI slots 706. The first interface card 712 is, for example, a SenSys CCD camera interface card. The second interface card 714 is, for example, a multiserial PCI board model COMHP7801-E by CyberResearch. The microscope controller 622 is connected to the parallel port.

In accordance with features of the invention, the software has modular architecture that allows easy expansion. Each unit has its own hardware-specific driver that translates the proprietary interface into a standardized programming API for the user-level applications. All software is designed for Windows 2000 Professional operating system, while it should be understood that the present invention is not limited to this operating system.

Computer and software subsystem 120 controls temperature gradient, automatic image and data acquisitions. Computer and software subsystem 120 provides automatic calculation of melting temperature and other melting parameters based upon acquired data. Computer and software subsytem 120 provides two modes for temperature control including temperature steps and smooth gradient. Computer and software subsystem 120 enables precision by temperature sensor of less than 0.1° C., error in temperature increments of less than 0.2° C., and an actual temperature error of less than 0.5° C.

Computer and software subsystem 120 includes an operating system 716 and a plurality of hardware-specific drivers #1-N, 118 stored in system memory 704. Hardware-specific drivers #1-N, 118 are provided for temperature monitor, controller self-calibration, humidity control, illumination control, detection control, and the like.

In accordance with features of the invention, software modules operate with such standard API so any portion of the software can be exchanged or upgraded without affecting other parts. One benefit of such a method is the simplicity of development and testing of code intended to work with real hardware without risk to the equipment. Also it makes possible to run service application without interruption to the main process as the scheme allows simultaneous hardware access for multiple programs.

While the present invention has been described with reference to the details of the embodiments of the invention shown in the drawing, these details are not intended to limit the scope of the invention as claimed in the appended claims.

What is claimed is:

1. An automated microscope comprising:
a temperature table including a thermal control subsystem for controlling a selected temperature of said temperature table;
said temperature table including a first stage liquid heat exchanger and a second stage fast temperature control;
an environmental conditioning subsystem for providing humidity control to prevent dew and ice from developing at a working side of the temperature table;
a computer coupled to said first stage liquid heat exchanger and said second stage fast temperature control for maintaining said selected temperature; and said computer coupled to said environmental conditioning subsystem for maintaining humidity control.

2. An automated microscope as recited in claim 1 wherein said selected temperature is provided in a range between −40 to 110 Celsius degrees.

3. An automated microscope as recited in claim 1 wherein said thermal control subsystem further includes a resistance sensor providing a temperature signal to said computer.

4. An automated microscope as recited in claim 1 wherein said thermal control subsystem further includes an overheating detector.

5. An automated microscope as recited in claim 1 wherein said environmental conditioning subsystem includes a computer-controlled valve coupled to an inert gas supply.

6. An automated microscope as recited in claim 5 wherein said inert gas supply includes a supply of Nitrogen.

7. An automated microscope as recited in claim 5 includes an electric fan for mixing air and said inert gas in a microscope chamber containing said temperature table.

8. An automated microscope as recited in claim 1 wherein said computer includes separate and independent software driver modules for said first stage liquid heat exchanger and said second stage fast temperature control, and said environmental conditioning subsystem.

9. An automated microscope as recited in claim 1 wherein said thermal control subsystem enables repeatability of less than 0.1 Celsius degrees for said selected temperature.

10. An automated microscope as recited in claim 1 wherein said environmental conditioning subsystem includes a dew point meter coupled to said computer.

11. An automated microscope as recited in claim 10 wherein said environmental conditioning subsystem includes a gas pressure control for controlling an amount of dry gas entering a microscope chamber.

12. An automated microscope as recited in claim 1 includes a liquid light guide directing light from a light source to a fiber optic ringlight.

13. An automated microscope as recited in claim 12 includes a plurality of excitation filters; said excitation filters being mounted on a first filterwheel exchanger for receiving excitation light from the fiber optic ringlight and filtering the excitation light applied to a specimen.

14. An automated microscope as recited in claim 13 includes a plurality of emission filters; said emission filters being mounted on a second filterwheel exchanger for receiving emission light from the specimen and filtering the emission light; said excitation filters and said emission filters being selectively provided to have different wavelength ranges that do not overlap; said computer coupled to said first filterwheel exchanger and said second filterwheel exchanger for independently changing the excitation filters and emission filters.

15. An automated microscope as recited in claim 14 includes a charge coupled diode (CCD) camera for detecting the filtered emission light.

16. An automated multicolor fluorescent microscope comprises:
a liquid light guide directing light from a light source to a fiber optic ringlight;
a plurality of excitation filters; said excitation filters being mounted on a first filterwheel exchanger for receiving excitation light from the fiber optic ringlight and filtering the excitation light applied to a specimen on a microscope table;
a plurality of emission filters; said emission filters being mounted on a second filterwheel exchanger for receiving emission light from the specimen and filtering the emission light;
said excitation filters and said emission filters being selectively provided to have different wavelength ranges that do not overlap;
a computer coupled to said first filterwheel exchanger and said second filterwheel exchanger for independently changing the excitation filters and emission filters; and
a charge coupled diode (CCD) camera for detecting the filtered emission light.

17. An automated multicolor fluorescent microscope as recited in claim 16 includes a positioning subsystem including X, Y and Z stages for selectively positioning said microscope table in X, Y and Z directions.

18. An automated multicolor fluorescent microscope as recited in claim 17 wherein positioning subsystem includes a respective motion controller for each of said X, Y and Z stages, each said motion controller receives commands from said computer.

19. An automated multicolor fluorescent microscope as recited in claim 16 includes a thermal control subsystem for controlling a selected temperature of said microscope table.

20. An automated multicolor fluorescent microscope as recited in claim 16 includes an environmental conditioning subsystem for providing humidity control to prevent dew and ice from developing at a working side of the temperature table.
